(19) United States
(12) Patent Application Publication
(10) Pub. No.: US 2017/0199435 A1
(43) Pub. Date: Jul. 13, 2017

(54) DISPLAY MOTHERBOARD, FABRICATING METHOD, DISPLAY PANEL, AND DISPLAY APPARATUS

(71) Applicants: BOE TECHNOLOGY GROUP CO., LTD, Beijing (CN); BEIJING BOE DISPLAY TECHNOLOGY CO., LTD., Beijing (CN)

(72) Inventors: Huishuang LIU, Beijing (CN); Xi CHEN, Beijing (CN); Liping LUO, Beijing (CN); Zengbiao SUN, Beijing (CN); Na FENG, Beijing (CN)

(21) Appl. No.: 15/325,334

(22) PCT Filed: May 20, 2016
(86) PCT No.: PCT/CN2016/082861

§ 371 Date: Jan. 10, 2017

(30) Foreign Application Priority Data
Aug. 7, 2015 (CN) 201510484835.3

(51) Int. Cl. G02F 1/1337; G02F 1/1345; G02F 1/1333; G02F 1/1335

(52) U.S. Cl. CPC G02F 1/133723; G02F 1/1337; G02F 1/133514; G02F 1/13454; G02F 1/133351; G02F 2201/121

(57) ABSTRACT

In accordance with various embodiments of the disclosed subject matter, a display motherboard, a fabricating method thereof, a related display panel, and a related display apparatus are provided. In some embodiments, the display motherboard comprises: a display region corresponding to each display unit to be formed; a non-display region around each display region; and an alignment layer disposed in the display region and the non-display region; wherein the alignment layer disposed in the display region and the non-display region has a single body structure.

### CROSS-REFERENCES TO RELATED APPLICATIONS

This PCT patent application claims priority of Chinese Patent Application No. 201510484835.3, filed on Aug. 7, 2015, the entire content of which is incorporated by reference herein.

### TECHNICAL FIELD

The disclosed subject matter generally relates to display technologies and, more particularly, relates to a display motherboard, a fabricating method thereof, a related display panel, and a related display apparatus.

### BACKGROUND

Liquid crystal display (LCD) has become a mainstream in the flat panel display market due to many advantages, such as small size, low power consumption, no radiation, and other characteristics. The liquid crystal display panel is a key component of a liquid crystal display device. Generally, a liquid crystal display panel includes an array substrate and a color filter substrate, and a liquid crystal between the array substrate and the color filter substrate.

In order to align the liquid crystals in the liquid crystal display panel in a specific direction under a power-off condition, an aligning layer, such as a polyimide (PI) film, can be formed between the array substrate and the color filter substrate.

### SUMMARY

In accordance with some embodiments of the disclosed subject matter, a display motherboard, a fabricating method thereof, a related display panel, and a related display apparatus are provided.

An aspect of the present disclosure provides a display motherboard, comprising: a display region corresponding to each display unit to be formed; a non-display region around each display region; and an alignment layer disposed in the display region and the non-display region; wherein the alignment layer disposed in the display region and the non-display region has a single body structure.

In some embodiments, the alignment layer disposed in the display region and the non-display region has an even thickness.

In some embodiments, the alignment layer is a polyimide (PI) film.

In some embodiments, the non-display region comprises a circuit configuration formed from a metal oxide conductive layer; and a portion of the alignment layer in the non-display region is located in a region without covering the circuit configuration.

In some embodiments, the circuit configuration is located in a top layer and being exposed.

In some embodiments, the display motherboard further comprises: a peripheral circuit located in a part of the non-display region; wherein the a portion of the alignment layer in the non-display region is located in a region without covering the peripheral circuit.

Another aspect of the present disclosure provides a display panel obtained by cutting the disclosed display motherboard.

In some embodiments, the display substrate is an array substrate; and the circuit configuration comprises at least one of the following: a circuit configuration in a gate on array (GOA) circuit, a circuit configuration in a pad area, and an electrode lead.

In some embodiments, the display substrate is a color filter substrate; and the circuit configuration comprises an electrode lead.

In some embodiments, the electrode lead comprises at least one of a common electrode lead and a touch line lead.

In some embodiments, the metal oxide conductive layer is made of a transparent metal oxide, including indium tin oxide or indium zinc oxide.

Another aspect of the present disclosure provides a display apparatus comprising a disclosed display panel.

Another aspect of the present disclosure provides a method for fabricating a display motherboard, comprising: forming an alignment layer in a display region corresponding to each of the display units to be formed, and a non-display region around each display unit, and an invalid region between adjacent display units; wherein the alignment layer has a single body structure.

In some embodiments, the alignment layer has a single body structure is formed in an one-time process.

In some embodiments, the method further comprises: before forming the alignment layer, forming a photoresist pattern layer covering a circuit configuration formed from a metal oxide conductive layer on the base substrate; wherein forming the alignment layer comprises: forming an alignment layer entirely covering the base substrate covered by the photoresist pattern layer; and removing a portion of the alignment layer that is covering the circuit configuration, or removing a portion of the alignment layer and a portion of the photoresist pattern layer that are covering the circuit configuration.

In some embodiments, a thickness of the photoresist pattern layer is larger than a thickness of the alignment layer; and a portion of the alignment layer covering the photoresist pattern layer and other portion of the alignment layer form a fault structure; and a side of the photoresist pattern layer is exposed because of the fault structure.

In some embodiments, the method further comprises: before forming the alignment layer, forming a photoresist pattern layer covering a peripheral circuit on the base substrate; wherein forming the alignment layer comprises: forming art alignment layer entirely covering the base substrate covered by the photoresist pattern layer; and removing a portion of the alignment layer that is covering the peripheral circuit, or removing a portion of the alignment layer and a portion of the photoresist pattern layer that are covering the peripheral circuit.

In some embodiments, the alignment layer is a polyimide (PI) film.

Another aspect of the present disclosure provides a display motherboard fabricated by the disclosed method.

Another aspect of the present disclosure provides a display panel obtained by cutting the disclosed display motherboard.

Other aspects of the present disclosure can be understood by those skilled in the art in light of the description, the claims, and the drawings of the present disclosure.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements. It should be noted that the following drawings are merely examples for illustrative purposes according to various disclosed embodiments and are not intended to limit the scope of the present disclosure.

FIG. 1 is a schematic diagram of an exemplary display motherboard in accordance with some embodiments of the disclosed subject matter;

FIG. 2 is a schematic. diagram of a conventional aligning layer;

FIG. 3 is a schematic diagram illustrating a processing stage for forming an alignment layer on a display motherboard in accordance with some other embodiments of the disclosed subject matter;

FIG. 4 is a schematic diagram illustrating another processing stage for forming an alignment layer on a display motherboard in accordance with some other embodiments of the disclosed subject matter;

FIG. 5 is a schematic diagram illustrating another processing stage for forming an alignment layer on a display motherboard in accordance with some other embodiments of the disclosed subject matter;

FIG. 6 is a schematic diagram illustrating another processing stage for forming an alignment layer on a display motherboard in accordance with some other embodiments of the disclosed subject matter; and

FIG. 7 is a schematic cross-sectional diagram of a display unit of an exemplary display motherboard in accordance with some embodiments of the disclosed subject matter.

### DETAILED DESCRIPTION

For those skilled in the art to better understand the technical solution of the disclosed subject matter, reference will now be made in detail to exemplary embodiments of the disclosed subject matter, which are illustrated in the accompanying drawings. Wherever possible, the same reference numbers will be used throughout the drawings to refer to the same or like parts.

In the related technology, in the narrow border products, some portion or the whole alignment layer may be coated on the peripheral circuits of the array substrate. In a high temperature and high humidity environment, the alignment layer has a strong water-absorption, so that the peripheral circuits may be easily electrochemically reacted. Particularly, for a gate on array (GOA) product, some GOA units work in a low pressure state for a long time, top layer signal circuits of the GOA units, such as an indium tin oxide (ITO) layer, may be deteriorated due to the electrochemical reactions, resulting in an abnormal of the screen displaying.

Accordingly, it is desirable to provide a display motherboard, a fabricating method thereof, a related display panel, and a related display apparatus to at least partially alleviate one or more problems set forth above and to solve other problems in the art.

In accordance with various embodiments, the disclosed subject matter provides a display motherboard, a fabricating method thereof, a related display panel, and a related display apparatus.

In some embodiments, the display motherboard can include a base substrate and at least one display unit on the base substrate. Each separated display unit was obtained by cutting the display motherboard. Each separated display unit includes a display region, a non-display region surrounding the display region, and a peripheral circuit in at least part area of the non-display region.

In some embodiments, a display motherboard comprises a display region corresponding to each of the display units to be formed; a non-display region around each display area; and an alignment layer disposed in the display region and the non-display region; the alignment layer disposed in the display region and the non-display region has a single body structure. In other words, the alignment layer of single body structure is an integral alignment configuration comprising display region alignment and non-display region alignment, the integral alignment is one-piece body or structure.

The alignment layer of single body structure can eliminate Halo regions that are surrounding display panels.

In some embodiments, an alignment layer is disposed on at least one display unit area. The alignment layer is disposed on integral substrate region other than the peripheral circuit of display unit.

In some other embodiments, a non-display region is not surrounding the display region. For example, the non-display region is in a frame region on one side of the display region, while other side of the display region are non-frame regions.

The peripheral circuit can include one or more suitable circuits, such as Gate On Array (GOA) circuit, welding pad circuit, different types of electrode leads including indium tin oxide (ITO) common electrode lead and of ITO touch line lead in the embedded touch screen, etc. The welding pad circuit is a pad area of connecting chip and electrode leads.

In the disclosed display motherboard, since the alignment layer is produced only on a region other than the peripheral circuit, the alignment layer does not directly contact with the peripheral circuit of the display unit. Thus an electrochemical reaction between the alignment layer and the peripheral circuit, and a consequent abnormal displaying can be avoided. In particular, when the alignment layer has a strong water absorption, and the peripheral circuit includes a circuit configuration that is made by a metal oxide semiconductor material (e.g., ITO, IZO, etc.), the disclosed subject matter can avoid the electrochemical reaction between the alignment layer and such circuit configuration, so as to avoid the corrosion of the circuit configuration.

In some embodiments of the disclosed display motherboard, each of the display unit corresponds to a display panel. For example, the display motherboard may be an array substrate motherboard including one or more array substrates or a color filter (CF) substrate motherboard including one or more color filter substrates. The array substrate motherboard and color filter (CF) substrate motherboard can be cut into display units. Each display unit can be an array substrate or a color filter (CF) substrate.

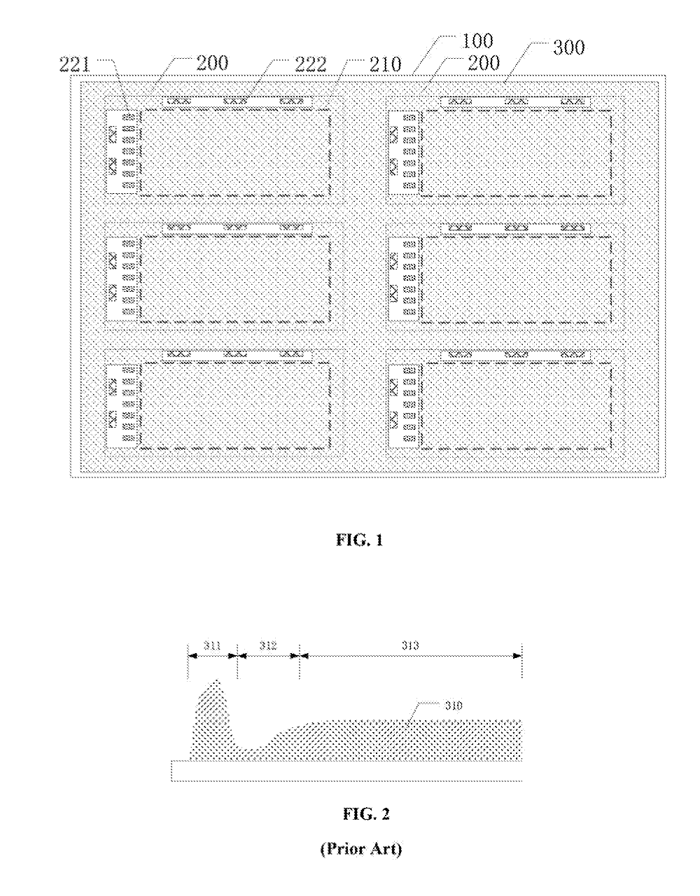

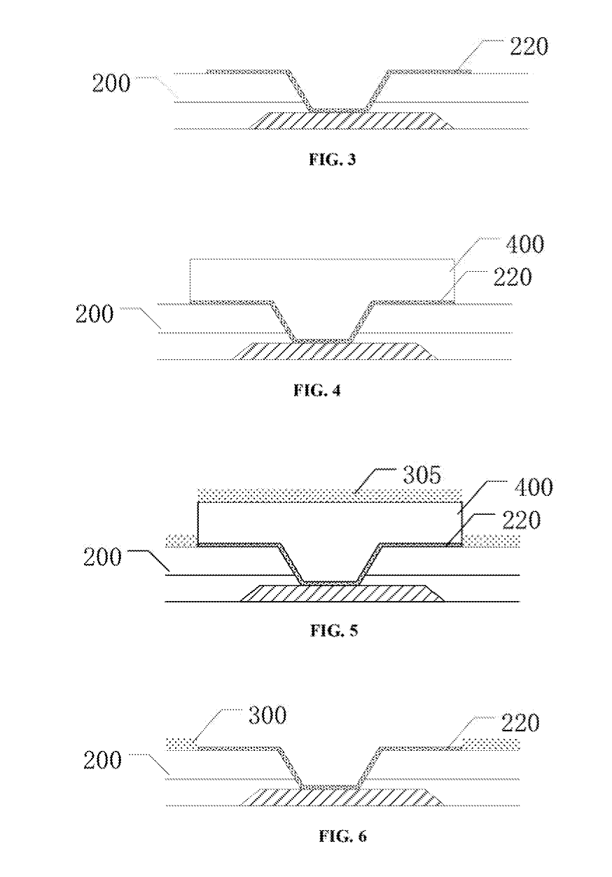

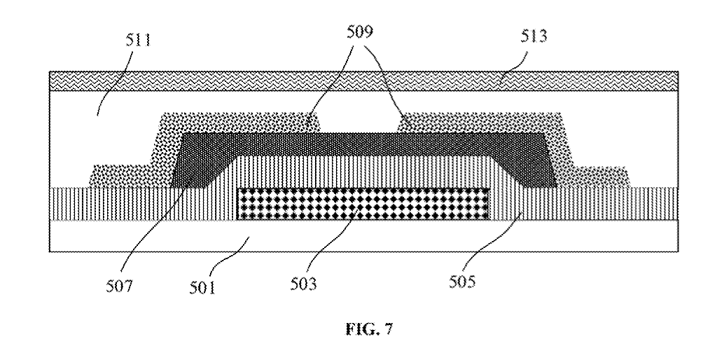

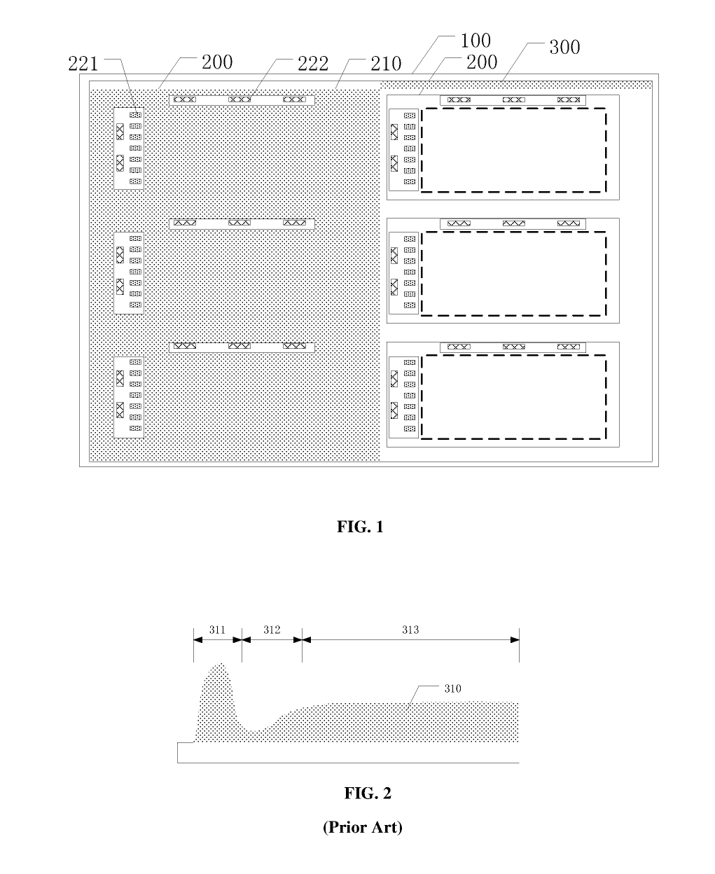

Referring to FIG. 1, a schematic diagram of an exemplary display motherboard is shown in accordance with some embodiments of the disclosed subject matter.

As illustrated, the display motherboard can be an array substrate motherboard including a base substrate 100, multiple display units or array substrates 200 on the base substrate 100. Each display unit 200 includes a display region shown inside of the dashed box 210, and a non-display region surrounding the display region shown outside of the dashed box 210.

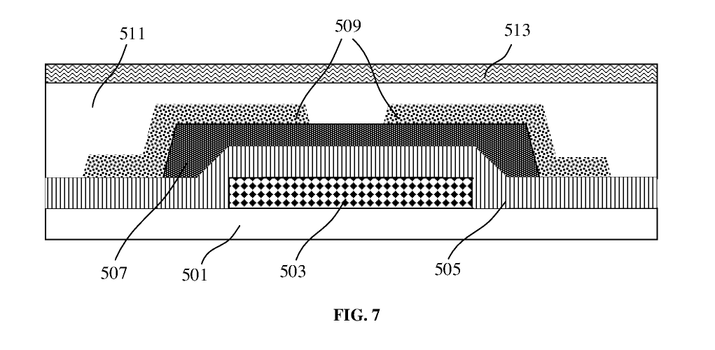

For each display unit, multiple sub-pixel units are provided in the display area for displaying. As illustrated in FIG. 7, each sub-pixel unit can include a gate electrode 503, a gate insulating layer 505, an active layer 507, a source/drain electrode layer 509, a pixel electrode layer 511 and a planarization layer 513, which are sequentially provided on the base substrate 501. On the surface of the non-display region, a peripheral circuit can be provided. The peripheral circuit can include a pad structure 222 in pad area, and a top layer signal circuit of the gate on array (GOA) units 221 in GOA area, such as an indium tin oxide (ITO) layer.

An alignment layer 300 can be formed on the surface of the array substrate motherboard. The alignment layer 300 can be, for example, a polyimide layer. For each display unit, the alignment layer 300 can completely cover the surface of the display region, and can cover the surfaces of the non-display region other than the peripheral circuit. The peripheral circuit of the array substrate avoid a direct contact with the alignment layer 300, and thus can avoid the electrochemical reaction there-between and the consequent abnormal displaying. The circuit configuration is located in a top layer and being exposed.

In some embodiments, the alignment layer 300 can be formed by a coating process and a curing process. In the coating, process, an aligning solution, such as a polyimide liquid can be coated on the integral base substrate 100 of display motherboard. In the curing process, the coated aligning solution can be evaporated.

During the existing curing process, the aligning solution located on the edge region aligning solvent has a faster evaporating rate. Due to the surface tension effect, the aligning solute continuously accumulates at the edge region of the coated aligning solution. Therefore, the edge region of the formed alignment layer usually includes an uneven region, such as a Halo region. For example, as illustrated in FIG. 2, in an edge region 311, the alignment layer 310 is thick, while in a region 312 close to a central region 313, the alignment layer 310 is thin.

In some embodiments of the disclosed subject matter, in order to avoid the adverse effects of the Halo region, the alignment layer 300 can also cover invalid regions between adjacent display units. in other words, in some embodiments, the alignment layer 300 can completely cover the integral base substrate 100 including an invalid region between adjacent display units, display region, and the non-display region, the alignment layer disposed in the display region and the non-display region has a single body structure.

Therefore, in the coating process, the aligning solution is not only coated in each display unit, but also coated in the regions between adjacent display units to form an aligning solution pattern. So the edge of the coated aligning solution pattern can be far away from the display units, and the Halo region of the solidified alignment layer 300 can also be far away from the display region of each display unit. Therefore, the Halo region can make no adverse effect for the displaying function.

The alignment layer disposed in the display region and the non-display region has an even thickness.

In some embodiments, the disclosed display motherboard can also be a color filter substrate motherboard. Each display unit on the color filter substrate motherboard can be a color filter base substrate including a display area and a non-display region surrounding the display region.

In the display region of each display unit, a light shielding matrix, a color filter layer, and a common electrode layer are subsequently disposed on the color filter base substrate. For each display unit, the display region is divided into multiple sub-pixel units. Each sub-pixel unit is configured for transmitting light of one color.

On the surface of the non-display region of each display unit, one or more peripheral circuits (e.g., Gate On Array (GOA) circuit, pad circuit, electrode lead, etc.) that are electrically connected with the common electrode layer in the display region can be provided as an electrode lead for the common electrode layer. For example, one peripheral circuit can be a common electrode lead. The common electrode layer and electrode lead is made of a metal oxide conductive layer.

An alignment layer can be formed on the surface of the color filter substrate motherboard. For each display unit, the alignment layer can completely cover the surface of the display region, and can cover the surfaces of the non-display region other than the peripheral circuit. The peripheral circuit a the color filter substrate avoid a direct contact with the aligning layer, and thus can avoid the electrochemical reaction there-between and the consequent abnormal displaying.

Further, the alignment layer can also cover the regions between adjacent display units. Therefore, the Halo region can make no adverse effect for the displaying function.

Another aspect of the disclosed subject matter provides a related display panel including at least one display unit of the display motherboard described above. The display panel is formed by combining and cutting an array substrate motherboard and a color filter substrate motherboard. At least one of the array substrate motherboard and the color filter substrate motherboard is an aforementioned display motherboard.

Another aspect of the disclosed subject matter provides a related display apparatus that includes a display panel described above. The display apparatus can be any suitable type of display device, such as a flat panel display device, or a flexible display device. Specific types of the display apparatus can include monitor, electronic paper, tablet computer, television, smart phone, smart tag, smart card, smart glasses, smart watch, digital photo frame, or any other device or component that has a display function.

Another aspect of the disclosed subject matter provides a method for fabricating a display motherboard.

The method can include forming an alignment layer in a display region corresponding to each of the display units to be formed, and a non-display region around each display unit, and an invalid region between adjacent display units; the alignment layer has a single body structure. The alignment layer has a single body structure is formed in one-time process.

The method further comprises: before forming the alignment layer, forming a photoresist pattern layer covering a circuit configuration formed from a metal oxide conductive layer on the base substrate

In some embodiments, forming the alignment layer comprises: forming an alignment layer entirely covering the base substrate covered by the photoresist pattern layer; and removing a portion of the alignment layer that is covering the circuit configuration, or removing a portion of the alignment layer and a portion of the photoresist pattern layer that are covering the circuit configuration.

In some embodiments, a thickness of the photoresist pattern layer is larger than a thickness of the alignment layer; and a portion of the alignment layer covering the photoresist pattern layer and other portion of the alignment layer form a fault structure; and a side of the photoresist pattern layer is exposed because of the fault structure.

The method can further comprise: before forming the alignment layer, forming a photoresist pattern layer covering a peripheral circuit on the base substrate; forming the alignment layer comprises: forming an alignment layer entirely covering the base substrate covered by the photoresist pattern layer; and removing a portion of the alignment layer that is covering the peripheral circuit, or removing a portion of the alignment layer and a portion of the photoresist pattern layer that are covering the peripheral circuit.

More specifically, the method can include the following exemplary steps.

Step S1: forming at least one display unit on a base substrate. Each display unit includes a display region, and a non-display region surrounding the display region. A peripheral circuit is provided on the surface of the non-display region.

Step S2: forming an alignment layer at least on the surface of the at least one display unit, but not on the peripheral circuit.

In some embodiments, in the fabricating method, multiple display units are formed on the base substrate. And the alignment layer also covers the region between adjacent display units. In one embodiment, an inkjet printing process can be performed for coating an aligning solution on the surface of the display motherboard. That is, in the coating process, the aligning solution is not only coated in each display unit, but also coated in the regions between adjacent display units. So the edge of the coated aligning solution pattern can be far away from the display units. In a followed curing process, the coated aligning solution can be evaporated, and a Halo region of the cured alignment layer can be far away from the display region of each display unit. Therefore, the Halo region can make no adverse effect for the displaying function.

In some embodiments, in order to form the alignment layer outside of the peripheral circuit, the step S2 may include the following exemplary steps.

Forming a photoresist pattern on the surface of each of the display unit. The photoresist pattern can include a photoresist removal area and a photoresist reserved area.

The photoresist reserved area corresponds to the region of peripheral circuit.

Coating an aligning solution on the surface of each display unit.

Curing the aligning solution and removing the photoresist pattern to form an aligning layer.

For example, referring to FIGS. 3-6, schematic diagrams of forming an alignment layer on a display motherboard are shown in accordance with some other embodiments of the disclosed subject matter.

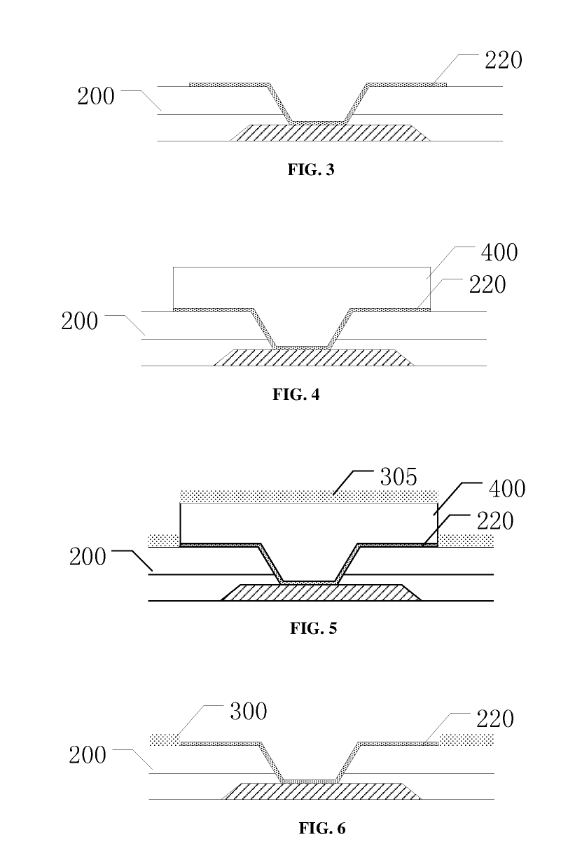

As illustrated in FIG. 3, a display unit 200 can include a peripheral circuit 220. A photoresist layer can be firstly coated on surface of the display unit 200, and then be exposed and developed to form a photoresist pattern 400 on the peripheral circuit 220 as shown in FIG. 4. In the photoresist pattern 400, a photoresist reserved area corresponds to the peripheral circuit 220, a photoresist removal area corresponds to other regions. Then an inkjet printing process or other suitable coating process can be performed for coating an aligning solution on the surface of the display motherboard. A pre-curing process and a main-curing process can be performed sequentially for evaporating the coated aligning solution. Thus an aligning film 305 can be formed over the entire upper surfaces as shown in FIG. 5. Next, a photoresist lift-off process can be performed to remove the photoresist pattern 400, so that a portion of the aligning film 305 on the peripheral circuit is removed to provide the desired alignment layer 300 as shown in FIG. 6.

In some other embodiments, the step S2 may include the following exemplary steps.

After coating the aligning solution on the surface of each display unit, curing the aligning solution to form an alignment film.

Forming a photoresist pattern on the surface of each of the display unit. The photoresist pattern includes a photoresist removal area and a photoresist reserved area. The photoresist removal area corresponds to the region of peripheral circuit.

Removing the aligning film in the photoresist removal area, and then removing the photoresist pattern.

In some embodiments, the disclosed method can be used for fabricating an array substrate motherboard. As illustrated in FIG. 7, in the array substrate motherboard, each display unit can include a gate electrode 503, a gate insulating layer 505, an active layer 507, a source/drain electrode layer 509, a pixel electrode layer 511 and a planarization layer 513, which are sequentially provided on the base substrate 501. The peripheral circuit can include a pad structure and a top layer signal circuit structure of the gate on array (GOA) units.

In some embodiments, the disclosed method can be used for fabricating a color filter substrate motherboard. In the color filter substrate motherboard, each display unit can include a light shielding matrix, a color filter layer, and a common electrode layer that are subsequently formed on the color filter base substrate. The peripheral circuit includes a signal input structure for the common electrode layer.

Accordingly, the disclosed method for fabricating a display motherboard can include using an entire coating mode to form an alignment film on an entire surface of a display motherboard, and then patterning the formed alignment film to make an alignment layer that is located on a surface of at least one display unit of the display motherboard but not on a peripheral circuit of the at least one display unit. Therefore, the formed alignment layer can not only maintain the electrical conductivity of each display unit and the peripheral circuit, but also eliminate the Halo region surrounding each display unit, and further avoid deterioration of the peripheral circuit caused by the aligning layer. Consequently, the method can improve the quality of the display panels fabricated by the display motherboard.

Another aspect of the disclosed subject matter provides display motherboard, comprising: a display region, a non-display region, and an alignment layer disposed in the display region and the non-display region. The alignment layer can be a polyimide (PI) film, and has a single body structure and an even thickness.

In some embodiments, the non-display region comprises a circuit configuration formed from a metal oxide conductive layer. The circuit configuration is located in a top layer and being exposed. A portion of the alignment layer in the non-display region is located in a region without covering the circuit configuration.

Another aspect of the disclosed subject matter provides a display panel obtained by cutting the disclosed display motherboard. In some embodiments, the display substrate is an array substrate, and the circuit configuration comprises one of a circuit configuration in a gate on array (GOA) circuit, a circuit configuration in a welding pad area, and an electrode lead. In some other embodiments, the display substrate is a color filter substrate, and the circuit configuration comprises an electrode lead. The electrode lead can be either a common electrode lead or a touch line lead. The metal oxide conductive layer can made of a transparent metal oxide, such as indium tin oxide, or indium zinc oxide.

Another aspect of the disclosed subject matter provides a method for fabricating a display motherboard. The method can include the following steps: forming a plurality of display units on a base substrate, wherein each display unit comprises a display region and a non-display region, and forming an alignment layer in the display region and the non-display region of each display unit, and an invalid region between adjacent display units. The alignment layer can be a polyimide (PI) film, and can be formed by using a coating method or an inkjet printing method, and can have a single body structure.

In some embodiments, before forming the alignment layer, a photoresist pattern layer covering a circuit configuration formed from a metal oxide conductive layer can be formed on the base substrate. A specific process for forming the alignment layer comprises forming an alignment layer entirely covering the base substrate covered by the photoresist pattern layer, and removing a portion of the alignment layer that is covering the circuit configuration, or removing a portion of the alignment layer and a portion of the photoresist pattern layer that are covering the circuit configuration.

The thickness of the photoresist pattern layer is larger than the thickness of the alignment layer. So a portion of the alignment layer covering the photoresist pattern layer and other portion of the alignment layer form a fault structure. A side of the photoresist pattern layer is exposed because of the fault structure.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, a display motherboard, a fabricating method thereof, a related display panel, and a related display apparatus are provided.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

1-20. (canceled)

21. A display motherboard, comprising:
a display region corresponding to each display unit to be formed;
a non-display region around each display region; and
an alignment layer disposed in the display region and the non-display region;
wherein the alignment layer disposed in the display region and the non-display region has a single body structure.

22. The display motherboard of claim 21, wherein:
the alignment layer disposed in the display region and the non-display region has an even thickness.

23. The display motherboard of claim 21, wherein the alignment layer is a polyimide (PI) film.

24. The display motherboard of claim 21, wherein:
the non-display region comprises a circuit configuration formed from a metal oxide conductive layer; and
a portion of the alignment layer in the non-display region is located in a region without covering the circuit configuration.

25. The display motherboard of claim 24, wherein:
the circuit configuration is located in a top layer and being exposed.

26. The display motherboard of claim 21, further comprising:
a peripheral circuit located in a part of the non-display region;
wherein the a portion of the alignment layer in the non-display region is located in a region without covering the peripheral circuit.

27. A display panel obtained by cutting the display motherboard according to claim 24.

28. The display panel of claim 27, wherein:
the display substrate is an array substrate; and
the circuit configuration comprises at least one of the following: a circuit configuration in a gate on array (GOA) circuit, a circuit configuration in a pad area, and an electrode lead.

29. The display panel of claim 27, wherein:
the display substrate is a color filter substrate; and
the circuit configuration comprises an electrode lead.

30. The display panel of claim 28, wherein:
the electrode lead comprises at least one of a common electrode lead and a touch line lead.

31. The display panel of claim 27, wherein:
the metal oxide conductive layer is made of a transparent metal oxide, including indium tin oxide or indium zinc oxide.

32. A display apparatus, comprising a display panel according to claim 27.

33. A method for fabricating a display motherboard, comprising:
forming an alignment layer in a display region corresponding to each of the display units to be formed, and a non-display region around each display unit, and an invalid region between adjacent display units;
wherein the alignment layer has a single body structure.

34. The method of claim 33, wherein:
the alignment layer has a single body structure is formed in an one-time process.

35. The method of claim 33, further comprising:
before forming the alignment layer, forming a photoresist pattern layer covering a circuit configuration formed from a metal oxide conductive layer on the base substrate;
wherein forming the alignment layer comprises:
forming an alignment layer entirely covering the base substrate covered by the photoresist pattern layer; and
removing a portion of the alignment layer that is covering the circuit configuration, or removing a portion of the alignment layer and a portion of the photoresist pattern layer that are covering the circuit configuration.

36. The method of claim 35, wherein:
a thickness of the photoresist pattern layer is larger than a thickness of the alignment layer; and
a portion of the alignment layer covering the photoresist pattern layer and other portion of the alignment layer form a fault structure; and
a side of the photoresist pattern layer is exposed because of the fault structure.

37. The method of claim 33, further comprising:
before forming the alignment layer, forming a photoresist pattern layer covering a peripheral circuit on the base substrate;
wherein forming the alignment layer comprises:
forming an alignment layer entirely covering the base substrate covered by the photoresist pattern layer; and
removing a portion of the alignment layer that is covering the peripheral circuit, or removing a portion of the alignment layer and a portion of the photoresist pattern layer that are covering the peripheral circuit.

38. The method of claim 33, wherein the alignment layer is a polyimide (PI) film.

39. A display motherboard fabricated by the method according to claim 33.

40. A display panel obtained by cutting the display motherboard according to claim 39.
